(19) United States
(12) Patent Application Publication
(10) Pub. No.: US 2021/0287224 A1
(43) Pub. Date: Sep. 16, 2021

(54) WALLET SERVER, COMPUTER READABLE RECORDING MEDIUM, AND WALLET SYSTEM

(71) Applicant: TOYOTA JIDOSHA KABUSHIKI KAISHA, Toyota-shi (JP)

(72) Inventors: Hiroto TOMIDA, Tokyo-to (JP); Tae SUGIMURA, Miyoshi-shi (JP); Ryuta YANAGISAWA, Ichikawa-shi (JP); Takuya TORIU, Tokyo-to (JP); Daisuke KOMIYAMA, Tokyo-to (JP); Zejun MEI, Fujimi-shi (JP); Kazuhiko YAMAGUCHI, Nagoya-shi (JP); Honami MORI, Nagoya-shi (JP)

(73) Assignee: TOYOTA JIDOSHA KABUSHIKI KAISHA, Toyota-shi (JP)

(21) Appl. No.: 17/168,460

(22) Filed: Feb. 5, 2021

(30) Foreign Application Priority Data
Mar. 13, 2020 (JP) 2020-044621

(51) Int. Cl. G06Q 20/40; G06Q 20/36; G06Q 20/22

(52) U.S. Cl. CPC G06Q 20/40155; G06Q 20/405; G06Q 20/2295; G06Q 20/3674

(57) ABSTRACT

A wallet server includes a processor including hardware, the processor being configured to: acquire position information about a first terminal carried by a watching target; determine whether the watching target enters a predetermined store, based on the position information; and permit the first terminal to make a payment within a range of the payment limit by outputting information about payment limit at the store to the first terminal when it is determined that the watching target enters the store.

The present application claims priority to and incorporates by reference the entire contents of Japanese Patent Application No. 2020-044621 filed in Japan on Mar. 13, 2020.

### BACKGROUND

The present disclosure relates to a wallet server, a computer readable recording medium, and a wallet system.

JP 2018-200535 A discloses a watching system that notifies a person to be notified who is associated with a watching target that the watching target has used a payment service.

### SUMMARY

There is a need for a wallet server, a computer readable recording medium, and a wallet system that improve the security in payment made by a watching target.

According to one aspect of the present disclosure, there is provided a wallet server including a processor including hardware, the processor being configured to: acquire position information about a first terminal carried by a watching target; determine whether the watching target enters a predetermined store, based on the position information; and permit the first terminal to make a payment within a range of the payment limit by outputting information about payment limit at the store to the first terminal when it is determined that the watching target enters the store.

### BRIEF DESCRIPTION OF THE DRAWINGS

FIG. 1 is a diagram schematically illustrating a configuration of a wallet system according to an embodiment;

FIG. 2 is a block diagram illustrating details of components of a wallet system according to an embodiment;

FIG. 3 is a diagram illustrating an example of information to be displayed on a first terminal in a wallet system according to an embodiment;

FIG. 4 is a diagram illustrating an example of information to be displayed on a first terminal in a wallet system according to an embodiment; and

FIG. 5 is a flowchart of an example of a payment method performed by a wallet system according to an embodiment.

### DETAILED DESCRIPTION

A wallet server, a computer readable recording medium storing a wallet program, and a wallet system according to an embodiment of the present disclosure will be described with reference to the drawings. Note that the components in the following embodiments include components that may be easily substituted by those skilled in the art or components that are substantially identical.

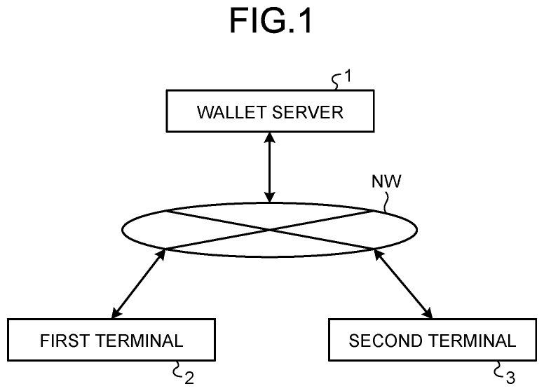

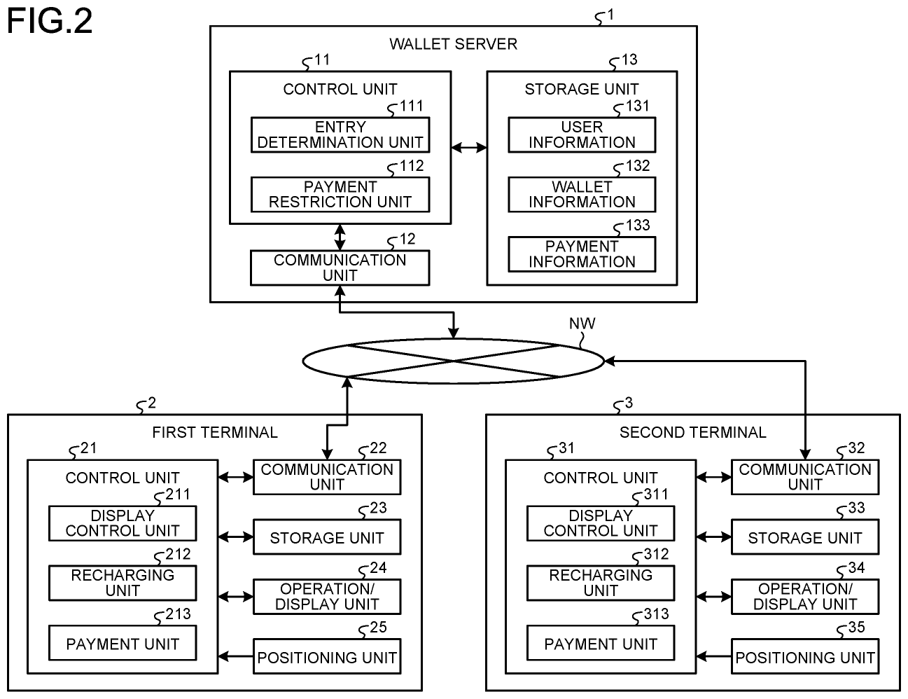

A configuration of the wallet system according to the embodiment will be described with reference to FIGS. 1 and 2. As illustrated in FIG. 1, the wallet system includes a wallet server 1, a first terminal 2, and a second terminal 3. In the wallet system, the wallet server 1, the first terminal 2, and the second terminal 3 are configured to communicate with each other through a network NW. The network NW includes, for example, an Internet network, a mobile phone network, or the like. In FIG. 1, only one first terminal 2 is illustrated, but there may be a plurality of first terminals 2.

The wallet server 1 is a server that manages the wallet system according to the embodiment. This wallet server 1 is achieved by a general-purpose computer such as a workstation or a personal computer. Furthermore, the wallet server 1 is managed by an administrator (provider) of the wallet system. As illustrated in FIG. 2, the wallet server 1 includes a control unit (first processor) 11, a communication unit 12, and a storage unit 13.

Specifically, the control unit 11 includes a processor such as a central processing unit (CPU), a digital signal processor (DSP), or a field-programmable gate array (FPGA), and a memory (main storage unit) such as a random access memory (RAM) and a read only memory (ROM). The control unit 11 loads a program stored in the storage unit 13 into a work area of the main storage unit to execute the program, controls each component unit through execution of the program, and achieves a function satisfying a predetermined purpose. The control unit 11 functions as an entry determination unit 111 and a payment restriction unit 112, through the execution of the program.

The entry determination unit 111 acquires position information about the first terminal 2 and determines whether a first user enters a predetermined store based on the position information. Note that the “predetermined store” means a store (merchant of the wallet service) where the wallet system may be used.

The payment restriction unit 112 restricts payment by the first terminal 2 when a predetermined condition is satisfied. Specifically, when the entry determination unit 111 determines that the first user enters the store, the payment restriction unit 112 outputs information about a payment limit at the store (hereinafter, referred to as “payment limit information”) to the first terminal 2. This permits the first terminal 2 to make a payment within the range of the payment limit. In this way, in the wallet system according to the embodiment, payment exceeding the payment limit is prohibited, and thus it is possible to prevent the first user (e.g., a watching target such as a child, an elderly person, etc.) from spending too much money from a wallet balance.

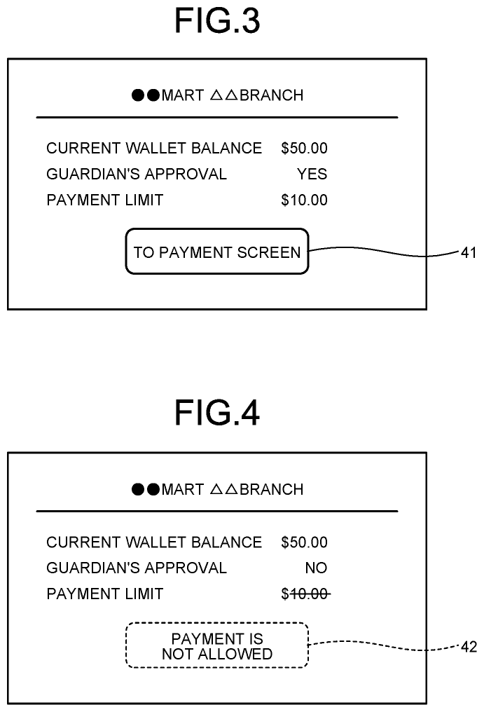

In addition, the payment restriction unit 112 may output the payment limit information to the first terminal 2, thereby causing an operation/display unit 24 of the first terminal 2 to display the payment limit information when the first user enters the store (see FIGS. 3 and 4). In this way, in the wallet system according to the embodiment, the payment limit is displayed on the operation/display unit 24 to cause the first user to acknowledge the payment limit in advance, and thus, it is possible to prevent the first user from spending too much money from a wallet balance.

In addition, the payment restriction unit 112 may inquire of the second terminal 3 whether to approve payment by the first terminal 2 to restrict the payment by the first terminal 2 based on a result thereof. In this case, when it is determined that the first user enters the store, the payment restriction unit 112 outputs the information about the permission/prohibition of payment at the store (hereinafter, referred to as “payment permission/prohibition information”) to the second terminal 3 associated with the first terminal 2.

Then, when information about payment approval (hereinafter, referred to as “payment approval information”) is acquired from the second terminal 3 based on operation of the second terminal 3 by the second user, information about payment permission (hereinafter, referred to as “payment permission information”) is output to the first terminal 2. This permits payment by the first terminal 2 at the store. On the other hand, when information about payment disapproval (hereinafter, referred to as “payment disapproval information”) is acquired from the second terminal 3 based on operation of the second terminal 3 by the second user, information about payment prohibition (hereinafter, referred to as “payment prohibition information”) is output to the first terminal 2. This prohibits payment by the first terminal 2 at the store. As described above, in the wallet system according to the embodiment, the first user inquires of the second user (e.g., guardian) about the permission/prohibition of payment in advance, thus making it possible to prevent the first user from making a payment without the permission of the second user. Therefore, the security in payment made by the first user may be improved.

In addition, the payment restriction unit 112 may output the payment approval information or payment disapproval information to the first terminal 2, thereby causing the operation/display unit 24 of the first terminal 2 to display the payment permission information or payment prohibition information when the first user enters the store (see FIGS. 3 and 4). In this way, in the wallet system according to the embodiment, whether the second user permits the payment that the first user is to make is displayed on the operation/display unit 24 to cause the first user to acknowledge whether the payment is permitted, and thus, it is possible to prevent the first user from spending too much money from a wallet balance.

In addition, the payment restriction unit 112 may restrict payment by the first terminal 2 at a store at which payment is prohibited in advance (hereinafter, referred to as a “store at which payment is prohibited”). Note that, for example, the “store at which payment is prohibited” may include any store at which the second user desires to prohibit payment by the first user or a store that is improper for the first user to enter from a legal or educational point of view. Information about the store at which payment is prohibited is stored in the storage unit 13 in advance.

In this case, when it is determined by the entry determination unit 111 that the first user enters the store at which payment is prohibited, the payment restriction unit 112 outputs the information about payment prohibition (hereinafter, referred to as “payment prohibition information”) to the first terminal 2. This prohibits payment by the first terminal 2 at the store at which payment is prohibited. In this way, in the wallet system according to the embodiment, payment at a specific store is prohibited, and thus, it is possible to prevent the first user from spending too much money from a wallet balance.

The communication unit 12 includes, for example, a local area network (LAN) interface board or a wireless communication circuit for wireless communication. The communication unit 12 is connected to the network NW such as the Internet that is a public communication network. Then, the communication unit 12 is connected to the network NW for communication with the first terminal 2 and the second terminal 3.

The storage unit 13 includes a recording medium such as an erasable programmable ROM (EPROM), a hard disk drive (HDD), or a removable medium. Note that examples of the removable medium include a disc recording medium such as a universal serial bus (USB) memory, a compact disc (CD), a digital versatile disc (DVD), and a Blu-ray (registered trademark) disc (BD). The storage unit 13 is configured to store an operating system (OS), various programs, various tables, various databases, and the like. Furthermore, the storage unit 13 stores, for each user of the wallet system, user information 131, wallet information 132, and payment information 133.

The user information 131 is information about a user who uses the wallet system. Examples of the user information 131 include a user ID, a password, a name, contact information (e.g., address, telephone number, email address, etc.), payment limit, and the like of a user who has applied to the wallet system in advance. Note that the user ID and password in the user information 131 are used for authentication processing such as for login to the wallet server 1.

The “payment limit” represents a limit of payment by a user at a store. The payment limit is set in advance for each user who uses the wallet system and for each store (merchant of the wallet system) where payment using the wallet system is available.

Furthermore, the payment limit changes depending on the age of each user. For example, the payment limit for a user who is a child is set lower than the payment limit for a user who is an adult. In addition, the payment limit changes depending on the type of a store. For example, in a case where the store is a store specializing in women's clothing, the payment limit for a user who is a man is set lower than the payment limit for a user who is a woman or set to 0. In other words, the amount of the payment limit is determined based on a relationship between a user and a store, that is, whether the user is the main target for the store.

The wallet information 132 is information about an electronic wallet (hereinafter, referred to as “wallet”) of the wallet system. The wallet represents a virtual account for electronic money. The wallet information 132 includes, for example, a user ID, a balance of electronic money, a recharge history of recharge with electronic money, an electronic money spending history, total points equivalent to electronic money, and the like.

The payment information 133 is information about payment by the wallet system. The payment information 133 includes a user ID, a payment means used for payment (e.g., electronic money payment (contactless payment), scan payment, code payment, etc.), a payment history, and the like.

The first terminal 2 is a mobile terminal carried by the first user. The “first user” in the present disclosure represents a person who uses the wallet system and is a watching target (person to be watched over). Furthermore, the “watching target” represents, for example, a child, an elderly person, or the like. The first user may deposit (hereinafter referred to as “recharge”) electronic money and make a payment using the electronic money through the first terminal 2. Examples of the first terminal 2 include a smartphone, mobile phone, tablet terminal, wearable computer, and the like of the first user.

As illustrated in FIG. 2, the first terminal 2 includes a control unit (second processor) 21, a communication unit 22, a storage unit 23, the operation/display unit (display) 24, and a positioning unit 25. The control unit 21, the communication unit 22, and the storage unit 23 are configured similarly to the control unit 11, the communication unit 12, and the storage unit 13. The control unit 21 functions as a display control unit 211, a recharging unit 212, and a payment unit 213, through the execution of the program.

The display control unit 211 controls contents displayed on the operation/display unit 24. The display control unit 211 causes the operation/display unit 24 to display predetermined information, based on the user's operation (touch operation, flick operation, or the like). Examples of the information displayed on the operation/display unit 24 by the display control unit 211 includes a membership registration screen used for the user to register as a member of the wallet system, a login screen used for logging in to the wallet system, a recharge screen used for recharging a wallet with electronic money, a payment limit display screen used for confirming a payment limit at a store (see FIGS. 3 and 4), a payment screen used for making a payment with electronic money, and the like.

As illustrated in FIGS. 3 and 4, the payment limit display screen displays thereon, for example, a store name, current wallet balance, the presence/absence of guardian's approval (payment permission information or payment prohibition information), payment limit, icons 41 and 42, and the like. The presence/absence of guardian's approval is information indicating whether the second user approves payment by the first user, and in a case of approval, “o” is displayed and in a case of disapproval, “x” is displayed. As illustrated in FIG. 3, when the approval “o” is displayed, the icon 41 used to proceed to the payment screen is displayed. On the other hand, as illustrated in FIG. 4, when the disapproval “x” is displayed, the icon 42 notifying that the payment is not allowed is displayed.

The recharging unit 212 recharges (deposits) the wallet with electronic money. Based on the user's operation, the recharging unit 212 outputs a recharge request for causing recharging means previously registered (associated) to recharge the wallet with electronic money, to the wallet server 1. Note that the “recharging means” represents means for recharging a wallet that is a virtual account with electronic money. Examples of the recharging means include a bank account, a credit card, and the like. A plurality of recharging means may be registered and a recharge may be made with electronic money also by any of the recharging means.

The control unit 11 of the wallet server 1 that has acquired the recharge request from the recharging unit 212 based on the first user's operation increases a balance of electronic money in the wallet of the first user, based on recharge amount information included in the recharge request. In other words, the control unit 11 updates the wallet information 132 about the first user stored in the storage unit 13, according to an increase in the balance of electronic money in the wallet of the first user.

Then, the control unit 11 outputs information indicating that recharging the wallet is completed (hereinafter, referred to as “recharge completion information”) to the first terminal 2. Furthermore, the control unit 11 outputs a money transfer request for an amount of money equivalent to a recharge amount to a server (payment service provider server) that manages a bank account or a credit card registered as recharging means by the first user.

Here, the recharging unit 212 may make a recharge by using a recharge balance of the second terminal 3 as the recharging means. In this case, the control unit 11 of the wallet server 1 that has acquired, from the recharging unit 212, the recharge request based on the first user's operation increases the balance of electronic money in the wallet of the first user, based on the recharge amount information included in the recharge request. In other words, the control unit 11 updates the wallet information 132 about the first user and the second user stored in the storage unit 13, according to an increase in the balance of electronic money in the wallet of the first user. At that time, the wallet balance of the first user is increased by the recharge amount, and the wallet balance of the second user is reduced by the recharge amount.

Then, the control unit 11 outputs information indicating that recharging the wallet is completed (hereinafter, referred to as “recharge completion information”) to the first terminal 2 and the second terminal 3. As described above, in the wallet system according to the embodiment, when the first terminal 2 makes a recharge with the electronic money, the recharge may be made from the wallet balance of the second terminal 3. For example, when the first user is a child and the second user is a parent, the child is allowed to make a recharge with electronic money from a wallet balance of the parent. Thus, even when the first user has no recharging means (e.g., bank account, credit card, or the like), recharging of the electronic money may be made.

Note that when the first terminal 2 makes a recharge with electronic money from the wallet balance of the second terminal 3, the recharge amount may be limited. In this case, the control unit 11 of the wallet server 1 that has acquired, from the recharging unit 212, the recharge request based on the first user's operation increases the balance of electronic money in the wallet of the first user, within the range of a predetermined deposit limit. As described above, in the wallet system according to the embodiment, the first terminal 2 is caused to make a recharge with electronic money from the wallet balance of the second terminal 3, within a preset amount, and thus, it is possible to prevent the first user from making an excessive recharge with electronic money from the wallet balance of the second terminal 3.

The payment unit 213 outputs, for example, a payment request for making a payment using electronic money recharged into the wallet, to a server (store server) provided in a store. The store server that has acquired the payment request from the first terminal 2 outputs the payment request including a payment amount, to the wallet server 1 via the network NW. The control unit 11 of the wallet server 1 that has acquired the payment request from the store server reduces the balance of electronic money in the wallet of the user based on the payment amount included in the payment request, and outputs the updated wallet information 132 and the payment information 133 to the first terminal 2. In addition, the control unit 11 outputs information indicating completion of the payment (hereinafter referred to as “payment completion information”) to the store server.

The storage unit 23 stores various screen data to be displayed on the operation/display unit 24 by the display control unit 211. Furthermore, in the storage unit 23, the position information about the first terminal 2 detected by the positioning unit 25, the user information 131, the wallet information 132, the payment information 133, and the like are stored, as needed.

The operation/display unit 24 includes, for example, a touch panel display and has an input function of receiving an operation by a user's finger, a pen, or the like and a display function of displaying various information based on the control of the display control unit 211.

The positioning unit 25 receives a radio wave from a global positioning system (GPS) satellite and detects the position information about the first terminal 2. Then, the control unit 21 stores the position information about the first terminal 2 detected by the positioning unit 25 in the storage unit 23.

The second terminal 3 is a mobile terminal carried by the second user. The “second user” in the present disclosure represents a person who uses the wallet system and watches over the watching target (guardian). The second user may make a recharge with electronic money and make a payment with the electronic money, through the second terminal 3, and control a payment by the first terminal 2. Examples of the second terminal 3 include a smartphone, mobile phone, tablet terminal, wearable computer, and the like of the second user.

As illustrated in FIG. 2, the second terminal 3 includes a control unit (third processor) 31, a communication unit 32, a storage unit 33, an operation/display unit (display) 34, and a positioning unit 35. The control unit 31, the communication unit 32, the storage unit 33, the operation/display unit 34, and the positioning unit 35 are configured similarly to the control unit 11, the communication unit 12, the storage unit 13, the operation/display unit 24, and the positioning unit 25. The control unit 31 functions as a display control unit 311, a recharging unit 312, and a payment unit 313, through the execution of the program. The functions of the display control unit 311, recharging unit 312, and payment unit 313 are similar to those of the display control unit 211, recharging unit 212, and payment unit 213, and a description thereof will be omitted.

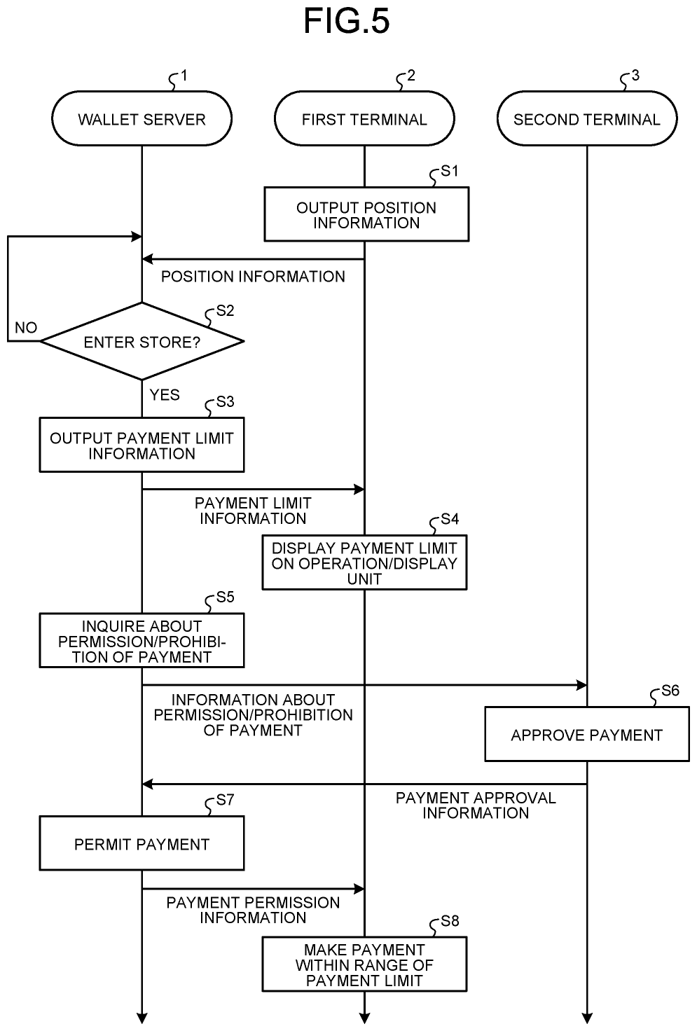

Hereinafter, an example of a payment method performed by the wallet system according to the embodiment will be described with reference to FIG. 5.

Firstly, the control unit 21 of the first terminal 2 outputs position information about the first terminal 2 detected by the positioning unit 25 to the wallet server 1 (Step S1). Subsequently, the entry determination unit 111 of the wallet server 1 determines whether the first user (watching target) enters a store based on the position information about the first terminal 2 (Step S2).

If it is determined that the first user does not enter the store (No in Step S2), the entry determination unit 111 returns to Step S2. On the other hand, if it is determined that the first user enters the store (Yes in Step S2), the entry determination unit 111 outputs payment limit information at the store to the first terminal 2 (Step S3). In response to this, the display control unit 211 of the first terminal 2 causes the operation/display unit 24 to display a payment limit thereon when the first user enters the store (Step S4).

In addition, the entry determination unit 111 outputs information about the permission/prohibition of payment at the store (inquiry about permission/prohibition of payment) to the second terminal 3 associated with the first terminal 2 (Step S5). If the payment is approved based on the operation of the second terminal 3 by the second user, the control unit 31 of the second terminal 3 outputs information indicating approval of payment (payment approval information) to the wallet server 1 (Step S6). In response to this, the control unit 11 outputs information indicating permission of payment (payment permission information) to the first terminal 2 (Step S7).

The first terminal 2 that has acquired the payment permission information makes a payment within the range of a set payment limit (Step S8). This is the end of this process.

As described above, according to the wallet server, the wallet program, and the wallet system according to the embodiment, payment exceeding the payment limit is prohibited, and thus it is possible to prevent the first user from spending too much money from a wallet balance. Therefore, the security in payment made by the first user may be improved.

Furthermore, in related technologies such as JP 2018-200535 A, there are methods of setting access restrictions to payment functions by using technologies such as biometric authentications. In specific cases (e.g., specific payment amount, specific store, etc.), however, services have poor flexibility, for example, the access restriction may not be canceled. On the other hand, the wallet server, the wallet program, and the wallet system according to the embodiment are configured to, for example, restrict payment to a specific payment amount or at a specific store, and thus, it is possible to provide a highly flexible payment service.

For example, in the wallet server, the wallet program, and the wallet system according to the embodiment, a payment exceeding the payment limit made by the first user is prohibited, but payment may be prohibited based on not the payment amount but an expense item to be purchased at the store.

In this case, when the entry determination unit 111 determines that the first user enters the store, the payment restriction unit 112 outputs information about an expense item that the first user is allowed to purchase at the store, to the first terminal 2. Therefore, the first terminal 2 is allowed to make a payment for only a preset expense item. In this way, permitting payment for only preset expense item makes it possible to prevent the first user from purchasing products that the first user should not purchase.

In the wallet server, the wallet program, and the wallet system according to the embodiment, the first terminal 2 is configured to make a recharge with electronic money from the wallet balance of the second terminal 3, and at that time, according to the status of payment by the first terminal 2, points equivalent to electronic money may be given to the second terminal 3.

For example, when the first terminal 2 makes a recharge with electronic money from the wallet balance of the second terminal 3, the wallet balance of the first terminal 2 after a predetermined period (e.g., one month) from the recharging date is compared with a preset proper amount of electronic money to be spent (hereinafter, referred to as “proper amount of money to be spent”). Then, the points to be given to the second terminal 3 are determined according to the absolute value of a difference between the wallet balance of the first terminal 2 and the proper amount of money to be used.

For example, consider that the first terminal 2 makes a recharge with electronic money equivalent to 1000 yen from the wallet balance of the second terminal 3 and the preset proper amount of money to be spent is 500 yen. In this case, when the wallet balance of the first terminal 2 after one month from the recharging date is 500 yen, the highest “100 points” will be given to the second terminal 3. In other words, when amount of money to be spent=proper amount of money to be spent, the highest points are given to the second terminal 3 because the first user spends money properly. Note that information about the points given to the second terminal 3 is held as the wallet information 132 in the storage unit 13 of the wallet server 1 and the storage unit 33 of the second terminal 3.

Furthermore, when the wallet balance of the first terminal 2 after one month from the recharging date is 0 yen (when all electronic money is spent in a month) or 1000 yen (when no electronic money is spent in a month), the lowest “0 point” is given to the second terminal 3. In other words, when all recharged electronic money equivalent to 1000 yen is spent or when no loaded electronic money is spent at all, the first user does not spend money properly, and thus, no point is given to the second terminal 3.

When the wallet balance of the first terminal 2 after one month from the recharging date has an amount excluding 500 yen and 0 yen (1 to 499 yen, 501 to 999 yen), the points to be given to the second terminal 3 are determined according to the absolute value of a difference from the proper amount of money to be spent (500 yen). As described above, giving the points to the second terminal 3 according to the amount of electronic money spent by the first user may encourage the first user (e.g., a child) to spend money appropriately, and thus, the first user may learn proper money spending.

According to the present disclosure, it is possible to improve the security in payment made by the watching target.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wallet server comprising
a processor comprising hardware, the processor being configured to:
acquire position information about a first terminal carried by a watching target;
determine whether the watching target enters a predetermined store, based on the position information; and
permit the first terminal to make a payment within a range of the payment limit by outputting information about payment limit at the store to the first terminal when it is determined that the watching target enters the store.

2. The wallet server according to claim 1, wherein the processor is configured to cause a display of the first terminal to display the information about payment limit by outputting the information about payment limit to the first terminal when the watching target enters the store.

3. The wallet server according to claim 1, wherein the processor is configured to:
output information about permission/prohibition of payment at the store, to a second terminal associated with the first terminal when it is determined that the watching target enters the store;
acquire information about payment disapproval from the second terminal; and
prohibit payment by the first terminal at the store by outputting information about payment prohibition to the first terminal when the information about payment disapproval is acquired.

4. The wallet server according to claim 3, wherein the processor is configured to cause a display of the first terminal to display the information about payment disapproval when the watching target enters the store by outputting the information about payment disapproval to the first terminal.

5. The wallet server according to claim 1, wherein the processor is configured to:
determine whether the watching target enters a predetermined store at which payment is prohibited, based on the position information; and
prohibit payment by the first terminal at the store at which payment is prohibited by outputting information about payment prohibition to the first terminal when it is determined that the watching target enters the store at which payment is prohibited.

6. The wallet server according to claim 3, wherein the processor is configured to:
acquire a deposit request for deposit of electronic money to an electronic wallet is acquired from the first terminal; and
deposit, when the deposit request is acquired, the electronic money from an electronic wallet of the second terminal to the electronic wallet of the first terminal.

7. The wallet server according to claim 6, wherein the processor is configured to deposit, when the deposit request is acquired from the first terminal, the electronic money from the electronic wallet of the second terminal to the electronic wallet of the first terminal, within a range of predetermined deposit limit.

8. A non-transitory computer-readable recording medium on which an executable program is recorded, the program instructing a processor to execute:
acquiring position information about a first terminal carried by a watching target;
determining whether the watching target enters a predetermined store, based on the position information; and
permitting the first terminal to make a payment within a range of the payment limit by outputting information about payment limit at the store to the first terminal when it is determined that the watching target enters the store.

9. The non-transitory computer-readable recording medium according to claim 8, wherein the program instructs the processor to execute causing a display of the first terminal to display the information about payment limit by outputting the information about payment limit to the first terminal when the watching target enters the store.

10. The non-transitory computer-readable recording medium according to claim 8, wherein the program instructs the processor to execute:
outputting information about permission/prohibition of payment at the store, to a second terminal associated with the first terminal when it is determined that the watching target enters the store; and
prohibiting payment by the first terminal at the store by outputting information about payment prohibition to the first terminal when information about payment disapproval is acquired from the second terminal.

11. The non-transitory computer-readable recording medium according to claim 10, wherein the program instructs the processor to execute causing a display of the first terminal to display the information about payment disapproval by outputting the information about payment disapproval to the first terminal when the watching target enters the store.

12. The non-transitory computer-readable recording medium according to claim 8, wherein the program instructs the processor to execute:
determining whether the watching target enters a predetermined store at which payment is prohibited, based on the position information; and
prohibiting payment by the first terminal at the store at which payment is prohibited by outputting information about payment prohibition to the first terminal when it is determined that the watching target enters the store at which payment is prohibited.

13. The non-transitory computer-readable recording medium according to claim 10, wherein the program instructs the processor to execute:
acquiring a deposit request for deposit of electronic money to an electronic wallet from the first terminal; and
depositing the electronic money from an electronic wallet of the second terminal to the electronic wallet of the first terminal when the deposit request is acquired.

14. The non-transitory computer-readable recording medium according to claim 13, wherein the program instructs the processor to execute depositing the electronic money from the electronic wallet of the second terminal to the electronic wallet of the first terminal, within a range of predetermined deposit limit when the deposit request is acquired from the first terminal.

15. A wallet system comprising:
a server comprising a first processor comprising hardware; and
a first terminal carried by a watching target, the first terminal comprising
a display, and
a second processor comprising hardware, the second processor being configured to output position information about the first terminal to the wallet server,
wherein the first processor is configured to
determine whether the watching target enters a predetermined store, based on the position information; and
permitting the first terminal to make a payment within a range of the payment limit by outputting information about payment limit at the store to the first terminal when it is determined that the watching target enters the store.

16. The wallet system according to claim 15, wherein
the second processor is configured to output the information about payment limit to the first terminal, and
the first processor is configured to cause the display to display the information about payment limit when the watching target enters the store.

17. The wallet system according to claim 15, further comprising
a second terminal associated with the first terminal, the second terminal comprising a third processor comprising hardware, wherein
the second processor is configured to
output information about permission/prohibition of payment at the store, to a second terminal associated with the first terminal when it is determined that the watching target enters the store, and
prohibiting payment by the first terminal at the store by outputting information about payment prohibition to the first terminal when information about payment disapproval is acquired from the second terminal.

18. The wallet system according to claim 17, wherein
the second processor is configured to output the information about payment disapproval to the first terminal, and
the first processor is configured to cause the display to display the information about payment disapproval when the watching target enters the store.

19. The wallet system according to claim 15, wherein the second processor is configured to:
determine whether the watching target enters a predetermined store at which payment is prohibited, based on the position information; and
prohibiting payment by the first terminal at the store at which payment is prohibited by outputting information about payment prohibition to the first terminal when it is determined that the watching target enters the store at which payment is prohibited.

20. The wallet system according to claim 17, wherein the second processor is configured to:
acquire a deposit request for deposit of electronic money to an electronic wallet from the first terminal; and
deposit the electronic money from an electronic wallet of the second terminal to the electronic wallet of the first terminal when the deposit request is acquired.
